(19) United States
(12) Patent Application Publication
(10) Pub. No.: US 2004/0112505 A1
(43) Pub. Date: Jun. 17, 2004

(54) Process for making reinforced glass of light weight

(76) Inventor: Kang Mei, Taiping City (TW)

Correspondence Address: CHARLES E. BAXLEY, 5th Floor, 59 John Street, New York, NY, 10038, US

(21) Appl. No.: 10/321,213

(22) Filed: Dec. 17, 2002

(51) Int. Cl. B32B 17/00

(52) U.S. Cl. 156/99

(57) ABSTRACT

A method for making a reinforced glass includes one or more layers of tempered glass layers and a base glass layer secured together by a transparent adhesive material so as to form a prototype. The prototype is then gradually pressurized to solidly secure the layers together. The transparent adhesive material is formed by melting and slowly stirring the polyurethane material and the acrylic material together and then slowly adding and stirring the epoxy material. The materials are slowly stirred together to prevent formation of air bubbles in the material.

### BACKGROUND OF THE INVENTION

1. Field of the Invention

The present invention relates to a reinforced glass, and more particularly to processes for manufacturing a reinforced or safety glass having light weight.

2. Description of the Prior Art

Typical reinforced glasses comprise one or more glass layers secured together by the typical adhesive materials. However, the typical adhesive materials may greatly decrease the transparency of the safety glasses. Furthermore, the number of glass layers may greatly increase the weight of the glass. When the reinforced and heavy glasses are used as windows for vehicles, the windows of reinforced glasses of greatly increasing weight may thus be difficult to be moved up and down by the motors of the vehicles.

U.S. Pat. No. 3,458,388 to Moynihan, and U.S. Pat. No. 5,622,580 to Mannheim disclose two of the typical laminated and reinforced glass members that have two or more glass sheets bonded together with adhesive materials. However, the reinforced glass members have no stronger insert or base materials for increasing the strength of the glass members.

The present invention has arisen to mitigate and/or obviate the afore-described disadvantages of the conventional glasses.

### SUMMARY OF THE INVENTION

The primary objective of the present invention is to provide a reinforced glass having an excellent transparency and having a light weight for allowing the reinforced glass to be easily operated or moved by motors of vehicles when the reinforced glass is used as windows in vehicles.

In accordance with one aspect of the invention, there is provided a method for making a reinforced glass, and comprising preparing a base glass layer having two sides, preparing and providing two tempered glass layers on the sides of the base glass layer, melting a polyurethane material and an acrylic material to a melted polyurethane material and a melted acrylic material respectively, blending the melted polyurethane material and the melted acrylic material together, slowly stirring the melted polyurethane material and the melted acrylic material to form a mixed melted material, and to prevent air bubbles from being formed in the mixed melted material, mixing an epoxy material and the mixed melted material together to form a blended material, slowly stirring the epoxy material and the mixed melted material to prevent air bubbles from being formed in the blended material, compressing the blended material to form a transparent adhesive material, disposing the transparent adhesive material between the base glass layer and the tempered glass layers, for securing the tempered glass layers and the base glass layer together to form a prototype, and pressurizing the prototype to solidly secure the tempered glass layers and the base glass layer together by the transparent adhesive material, in order to form the reinforced glass. The reinforced glass includes an increased strength, and a reduced weight, and is thus excellent for being made as windows of vehicles.

The prototype is preferably disposed in a pressurized container with a gradually pressurized air for allowing the layers to be solidly secured together.

One or more release layers may further be provided and covered onto the transparent adhesive material, and the transparent adhesive material will then be formed into a roll for further use.

Further objectives and advantages of the present invention will become apparent from a careful reading of a detailed description provided hereinbelow, with appropriate reference to accompanying drawings.

### BRIEF DESCRIPTION OF THE DRAWINGS

FIGS. 1 and 2 are block diagrams illustrating a method in accordance with the present invention for forming or manufacturing a reinforced glass, and

FIG. 3 is a cross sectional view illustrating a reinforced glass to be manufactured by the method in accordance with the present invention.

### DETAILED DESCRIPTION OF THE PREFERRED EMBODIMENT

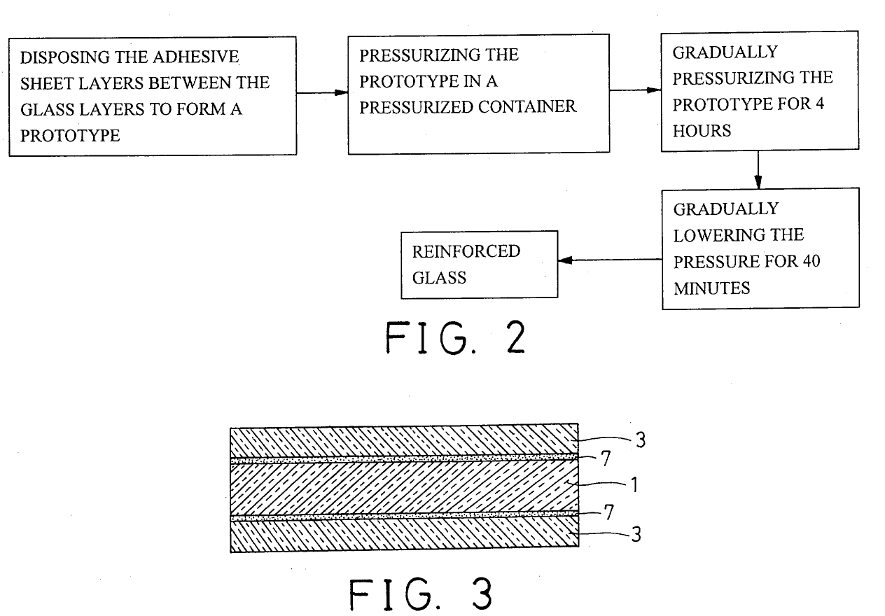

Referring to the drawings, a method in accordance with the present invention is provided for manufacturing a reinforced glass, as shown in FIG. 3, which includes an excellent transparency and which includes a light weight. The reinforced glass comprises an insert or an intermediate base layer 1 of such as polymer materials, and one or more layers of tempered glass layers 3 secured onto the polymer layer 1 by one or more layers of transparent adhesive layers 7.

The base layer 1 may be made of polymer materials, such as polycarbonate materials or polyester materials. The transparent adhesive layers 7 are made of polyurethane material (PU) (including about 30-50% by weight), acrylic material (including about 30-50% by weight) and epoxy material (including about 10-20% by weight) and may be made by the following processes.

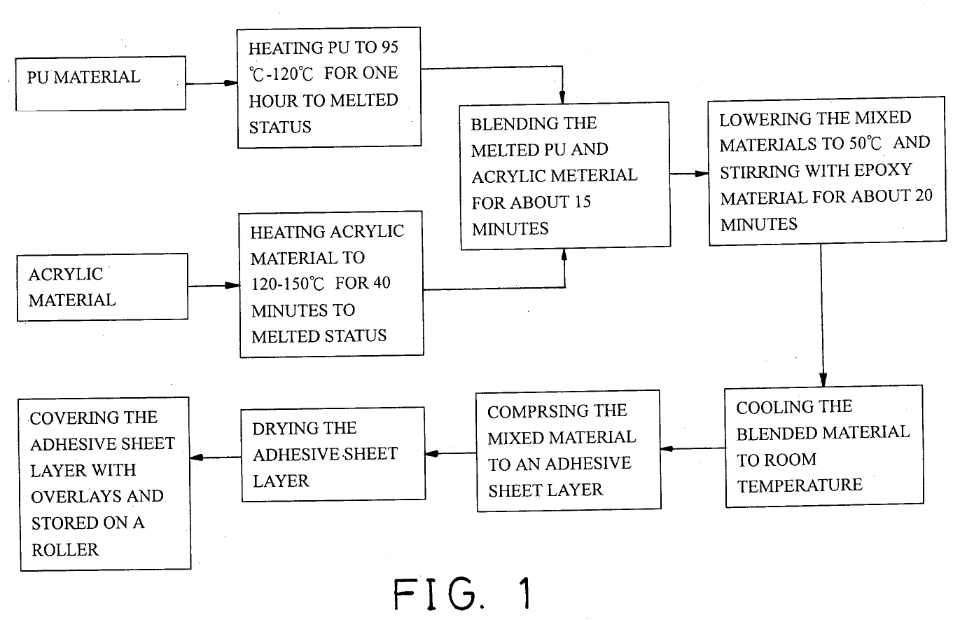

As shown in FIG. 1, the polyurethane material (PU) is first melted and heated to about 95-120° C. for about 1 hour. The acrylic material is also melted and heated to about 120-150° C. for about 40 minutes. The melted polyurethane material and the melted acrylic material are then mixed together and slowly stirred and blended for about 15 minutes for allowing both of the materials to be completely mixed together. The slowly stirring is conducted for preventing the generation of air bubbles in the melted materials.

Both of the melted materials are preferably kept heated to about 95-150° C. during the stirring or mixing or blending process. The mixed melted materials include an excellent transparency and are then lowered to a temperature of about 50° C. The epoxy material is then added into the mixed and melted materials and slowly stirred for about 20 minutes in order to form a transparent final mixed material.

The transparent and mixed material is then cooled to room temperature, and then compressed by pairs of rollers or extruded by machines to form the transparent adhesive sheet layer 7. The adhesive sheet layer 7 will then dried naturally, or under room temperature. The thickness of the transparent adhesive layer 7 may be varied or determined or selected according to the user's requirements.

The transparent adhesive sheet layer 7 then has one or both sides thereof covered with protective overlays or release layers for further use. The protected or covered adhesive sheet layer 7 may then be wound or stored on a roller or a pulley or formed into a roll for being applied between glass layers or the like, to adhere the glass layers together.

As shown in FIG. 2, the transparent adhesive layers 7 are then disposed between the tempered glass layers 3 and the base layer 1 after the overlays and/or the release layers are removed from the transparent adhesive layers 7, so as to form a superposed prototype. The prototype is then disposed in and pressurized by a pressurized container into which pressurized air is filled for pressurizing the prototype.

The pressure is preferably gradually increased and preferably ranges from 0-14 kg/cm² and is preferably lasted for about 4 hours in order to suitably pressurizing the prototype and in order to solidly secure the layers 1, 3, 7 together. Alternatively, actuators, such as hydraulic or pneumatic cylinders may be used for pressurizing the prototype. The pressure applied to the prototype is then gradually lowered and last for about forty (40) minutes before the reinforced is glass is formed.

Normally, the tempered glass 3 has a transparency of about 92 degrees, and the polymer layer 1 has a transparency of about 87 degrees. The reinforced glass formed by the glass layers 3, 1 and the transparent adhesive layers 7 may include a transparency of about 82-85 degrees. The base layer 1 includes an excellent strength, such as an excellent impact-resistant strength, and preferably includes a thickness greater than that of each glass material 3, such that the provision of base layer 1 may decrease the number of layers of the tempered glass material 3, and such that the weight of the reinforced glass may be suitably decreased.

The reinforced glass material thus includes an increased strength and includes a reduced weight, and may thus be used for forming light weight windows for vehicles, and the windows of reduced weight may then be suitably actuated or moved by motors of vehicles.

Accordingly, the method in accordance with the present invention may be used for making a reinforced glass that includes an excellent transparency and that includes a light weight for allowing the reinforced glass to be easily operated or moved by the motors when the reinforced glass is used in the vehicles.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A method for making a reinforced glass, the method comprising:
a) preparing a base glass layer having two sides,
b) preparing and providing two tempered glass layers on the sides of the base glass layer,
c) melting a polyurethane material and an acrylic material to a melted polyurethane material and a melted acrylic material respectively,
d) blending the melted polyurethane material and the melted acrylic material together,
e) slowly stirring the melted polyurethane material and the melted acrylic material to form a mixed melted material, and to prevent air bubbles from being formed in the mixed melted material,
f) mixing an epoxy material and the mixed melted material together to form a blended material,
g) slowly stirring the epoxy material and the mixed melted material to prevent air bubbles from being formed in the blended material,
h) compressing the blended material to form a transparent adhesive material,
i) disposing the transparent adhesive material between the base glass layer and the tempered glass layers, for securing the tempered glass layers and the base glass layer together to form a prototype, and
j) pressurizing the prototype to solidly secure the tempered glass layers and the base glass layer together by the transparent adhesive material.

2. The method according to claim 1, wherein the prototype is disposed in a pressurized container with a gradually pressurized air.

3. The method according to claim 1 further comprising preparing and covering at least one release layer onto the transparent adhesive material, and forming the transparent adhesive material into a roll.
